(19) United States
(12) Patent Application Publication
(10) Pub. No.: US 2012/0235018 A1
(43) Pub. Date: Sep. 20, 2012

(54) OPTICAL TOUCH SYSTEM AND METHOD

(75) Inventor: Yu-Kuo Cheng, Kaohsiung City (TW)

(73) Assignee: Sunplus Innovation Technology Inc., Hsinchu (TW)

(21) Appl. No.: 13/307,196

(22) Filed: Nov. 30, 2011

(30) Foreign Application Priority Data
Mar. 17, 2011 (TW) 100109214

(51) Int. Cl. G01C 21/00

(52) U.S. Cl. 250/206.1

(57) ABSTRACT

An optical touch system and an optical touch method are provided. The optical touch system includes a scanning unit, a light source, a detector, a first light collecting unit and a second light collecting unit. The scanning unit provides an incident ray in a first direction. At least a portion of the energy of a reflected ray corresponding to the incident ray in a second direction is received by the first light collecting unit and collected to the detector. A retro-reflected ray corresponding to the incident ray in the first direction is received by the second light collecting unit and collected to the detector.

This application claims the benefit of Taiwan Patent Application Serial No. 100109214, filed Mar. 17, 2011, the subject matter of which is incorporated herein by reference.

### FIELD OF THE INVENTION

The present invention relates to an optical touch system and an optical touch method, and more particularly to an optical touch system and an optical touch method using retro-reflected and diffuse-reflected rays to implement an optical touch operation.

### BACKGROUND OF THE INVENTION

Nowadays, the demand on the touch technology is progressively increasing because it can provide a user-friendly and intuitive user-machine interface. The basic principle of the touch technology is to detect a position of a touching point within a predetermined touch-sensitive zone.

A scanning-type optical touch technology utilizes optical principles to implement the optical touch operation. Conventionally, the scanning-type optical touch technology is implemented according to the light-sheltering property of the touching object, e.g., a stylus, a finger, etc. The scanning-type optical touch technology employs an incident ray to scan the touch-sensitive zone. Once the incident ray strikes the touching object, the incident ray is sheltered by the touching object. That is, along the light path from the light source to the touching object, a shadow, opposed to the light source, is formed at the backside of the touching object. After the position of the shadow is detected by photodetectors, the position of the touching point can be calculated. However, since this technology needs to install lots of photodetectors or reflective tapes on three edges of the touch-sensitive zone, the fabricating cost is very high.

Another conventional scanning-type optical touch technology is implemented according to the reflective property of the touching object. Depending on the directions of the reflected rays corresponding to an incident ray striking an object, these reflected rays may be classified into a mirror-reflected ray, diffuse-reflected rays and a retro-reflected ray because of specular reflection, diffuse reflection and retro-reflection, respectively. The traveling direction of the retro-reflected ray is opposed to the travelling direction of the incident ray. For implementing the optical touch operation by means of retro-reflection, the incident ray sequentially scan across a range of angle of the touch-sensitive zone. When the incident ray strikes the touching object at a specific angle, a retro-reflected ray is returned back to the light source in a direction reverse to that of the incident ray. According to the scanning mode, the occurrence of the retro-reflected ray detected by the photodetector and/or the scanning angle corresponding to the occurrence of the retro-reflected ray, the position of the touching point can be calculated.

However, the optical touch operation by means of retro-reflection still has some drawbacks. For example, since the intensity of the retro-reflected ray is relatively weak, the use of only the retro-reflected ray to implement the optical touch operation usually results in a low signal-to-noise ratio and fails to accommodate the variation of the retro-reflection from different touching objects. Generally, the intensity of the retro-reflected ray is highly dependent on the shape and the outer surface of the touching object. Moreover, the intensity of the retro-reflected ray from a finger and the intensity of the retro-reflected ray from a touch pen are distinguished. In some situations, the optical touch technology by means of retro-reflection needs a specially-designed touch pen to result in effective detection. That is, the conventional optical touch technology by means of retro-reflection is not user-friendly.

### SUMMARY OF THE INVENTION

For obviating the drawbacks encountered from the prior art, the present invention provides an optical touch system using retro-reflected and diffuse-reflected rays to implement an optical touch operation. When an incident ray strikes an object, the energy of the incident ray is largely or mostly diffuse-reflected. Consequently, the optical touch operation may be implemented according to the diffuse-reflected ray. Moreover, for increasing the signal-to-noise ratio, the optical touch operation may be implemented according to the diffuse-reflected ray and the retro-reflected ray.

An embodiment of the present invention provides an optical touch system. The optical touch system includes a touch-sensitive zone, a first optical touch module, a second optical touch module and a micro controller unit. The first optical touch module is arranged at a first side of the touch-sensitive zone for providing a first incident ray to the touch-sensitive zone. The second optical touch module is arranged at a second side of the touch-sensitive zone for providing a second incident ray to the touch-sensitive zone. The first incident ray and the second incident ray are alternately provided by the first optical touch module and the second optical touch module. When the first incident ray and the second incident ray strike a touching point within the touch-sensitive zone, a plurality of reflected rays are reflected by the touching object. The reflected rays are detected by the first optical touch module and the second optical touch module, so that a plurality of detecting values are outputted. The micro controller unit receives the detecting values from the first optical touch module and the second optical touch module, thereby calculating a position of the touching point within the touch-sensitive zone.

Another embodiment of the present invention provides an optical touch method for use in an optical touch system including a first optical touch module and a second optical touch module. Firstly, a first incident ray and a second incident ray are alternately provided by the first optical touch module and the second optical touch module, respectively. The light intensities of a plurality of reflected rays produced when the first incident ray and the second incident ray strike a touching object are detected, and thus a plurality of detecting values are acquired. According to the a plurality of detecting values, a position of the touching point within a touch-sensitive zone is calculated.

A further embodiment of the present invention provides an optical touch system. The optical touch system includes a touch-sensitive zone, a first optical touch module and a micro controller unit. The first optical touch module includes a first scanning unit for providing a first incident ray in a first direction, and an external detector for detecting a reflected ray corresponding to the first incident ray in a second direction, wherein the second direction is not parallel with the first direction. The micro controller unit is used for controlling the first optical touch module and receiving a detecting value from the external detector, thereby calculating a position of a touching point within a touch-sensitive zone.

A still embodiment of the present invention provides an optical touch method for use in an optical touch system including a first optical touch module and a second optical touch module. The first optical touch module includes a first scanning unit. The second optical touch module includes a second detector. The optical touch method includes steps of providing a first incident ray in a first direction by the first scanning unit, and allowing the second detector to receive a reflected ray corresponding to the first incident ray in a second direction, wherein the second direction is not parallel with the first direction.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrates various types of reflected rays;

FIG. 2 schematically illustrates an optical touch system according to an embodiment of the present invention;

FIG. 3 schematically illustrates an optical touch operation implemented in the optical touch system of the present invention;

FIG. 4 schematically illustrates another basic optical touch structure used in the optical touch system of the present invention;

FIG. 5 schematically illustrates a variant example of an optical touch module used in the basic optical touch structure of FIG. 4;

FIG. 6 schematically illustrates another exemplary optical touch module used in the basic optical touch structure of the present invention;

FIG. 7 schematically illustrates another basic optical touch structure used in the optical touch system of the present invention;

FIG. 8 schematically illustrates a variant example of a basic optical touch structure of FIG. 7; and

FIG. 9 schematically illustrates a variant example of the optical touch module of FIG. 6.

### DETAILED DESCRIPTION OF PREFERRED EMBODIMENTS

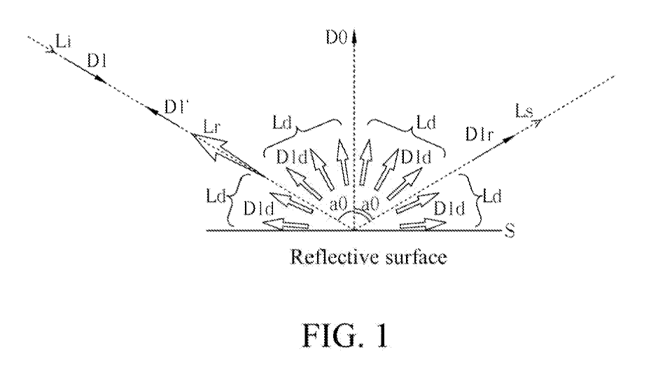

FIG. 1 schematically illustrates various types of reflected rays. When an incident ray Li propagating in the direction D1 strikes a reflective surface S, a mirror-reflected ray Ls, many diffuse-reflected rays Ld and a retro-reflected ray Lr are produced because of mirror reflection, diffuse reflection and retro-reflection, respectively. Since the angle between the travelling direction D1 of the incident ray Li and the normal D0 of the reflective surface S is a0, the angle between the traveling direction D1r of the mirror-reflected ray Ls and the normal D0 is also a0. The diffuse-reflected rays Ld are reflected in widespread directions D1d. The traveling direction D1′ of the retro-reflected ray Lr is in parallel with and opposed to the travelling direction D1 of the incident ray Li. In accordance with the present invention, the characteristics of the reflected rays Ld and Lr are employed to implement optical touch control. Moreover, the wavelengths of the incident ray and the reflected rays mentioned above are in a wide range of radiation spectrum, including visible and invisible bands. Among the range of radiation spectrum, the radiation of infrared is preferred because of the invisibility during the touch operation.

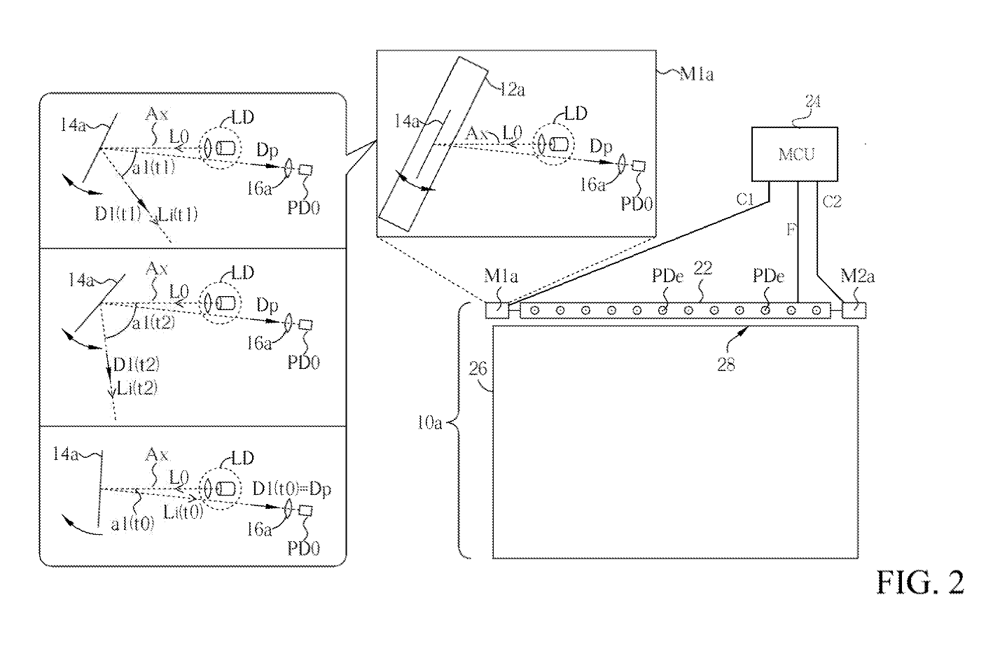

FIG. 2 schematically illustrates an optical touch system according to an embodiment of the present invention. As shown in FIG. 2, the optical touch system comprises a basic optical touch structure 10a and a micro controller unit (MCU) 24. The basic optical touch structure 10a comprises two optical touch modules M1a, M2a, a detecting module 22 and a touch-sensitive zone 26. The two optical touch modules M1a, M2a and the detecting module 22 are used for detecting a position of a touching point within the touch-sensitive zone 26. The two optical touch modules M1a and M2a are respectively arranged at both sides of an edge 28 of the touch-sensitive zone 26. The detecting module 22 comprises a plurality of detectors PDe (i.e. photodetectors). These detectors PDe are arranged along the edge 28 of the touch-sensitive zone 26 and between the two optical touch modules M1a and M2a.

Moreover, according to a first operating signal C1 and a second operating signal C2, the micro controller unit 24 cooperates with the two optical touch modules M1a, M2a to perform a touch control operation. In addition, the detecting module 22 generates a detecting value F to the micro controller unit 24. According to the relation between the first operating signal C1, the second operating signal C2 and the detecting value F, the micro controller unit 24 calculates a position of a touching point. The information associated with the position of a touching point is transmitted to a host (not shown). The operations of the optical touch modules M1a and M2a will be illustrated as follows.

Since the configurations and functions of the optical touch module M2a are similar to those of the optical touch module M1a, only the operations of the optical touch module M1a will be illustrated as follows. The optical touch module M1a comprises a scanning unit 12a, a light source unit LD, a light collecting unit 16a and a detector PD0. The light source unit LD may further comprise an optical mechanism associated with the light source (e.g. LED). The optical mechanism includes for example the optical elements for collecting the ray (e.g. a collimating lens or a lens set) and/or the optical elements for changing the path of the ray (e.g. a mirror or a prism). The light source unit LD provides an initial ray L0 to the scanning unit 12a along an optical axis Ax. Similarly, the light collecting unit 16a (i.e. a basic light collecting unit) may comprise the optical elements for collecting the ray (e.g. a collimating lens or a lens set) and/or the optical elements for changing the path of the ray (e.g. a mirror or a prism). By the light collecting unit 16a, the ray propagating in a predetermined direction Dp is collected to the detector PD0 to be used as a basis of calculating the position of a touching point by the micro controller unit 24.

The scanning unit 12a comprises a mirror 14a and a servo mechanism (not shown in FIG. 2). The servo mechanism is configured to change an angle of the mirror 14a. For example, the servo mechanism is implemented by a microelectromechanical system (MEMS) technology. By the mirror 14a of the scanning unit 12a, the initial light beam is reflected as an incident ray to be directed to the touch-sensitive zone 26. As the angle of the mirror 14a changes with time, the propagating direction of the incident ray is changed and thus the touch-sensitive zone 26 is scanned by the incident ray. The scanning schedule of the scanning unit 12a is also illustrated in FIG. 2. At a time spot t1, the initial ray L0 is reflected by the mirror 14a, so that an incident ray Li(t1) propagating in a direction D1(t1) is produced, wherein an angle between the direction D1(t1) and the optical axis Ax is a1(t1). The mirror 14a is rotated in a clockwise direction. At the time spot t2, the initial ray L0 is reflected by the mirror 14a, so that an incident ray Li(t2) propagating in a direction D1 (t2) is produced, wherein an angle between the direction D1(t2) and the optical axis Ax is a1(t2). The rest may be deduced by analogy.

At a specified time t0, the mirror 14a is rotated such that an angle between the direction D1(t0) of the incident ray Li(t0) and the optical axis Ax is a1(t0). Meanwhile, the direction D1(t0) of the incident ray Li(t0) is the same as the predetermined direction Dp of the ray directed to the light collecting unit 16a. Under this circumstance, the incident ray Li(t0) can be detected by the detector PD0. Once the incident ray Li(t0) is received by the detector PD0, it means that the incident ray in the predetermined direction Dp has been scanned. Consequently, the detecting result of the detector PD0 may be used to indicate the scanning progress (e.g. the start scanning time and the final scanning time). That is, the detecting result of the detector PD0 can be used as a basis of calculating the position of a touching point by the micro controller unit 24.

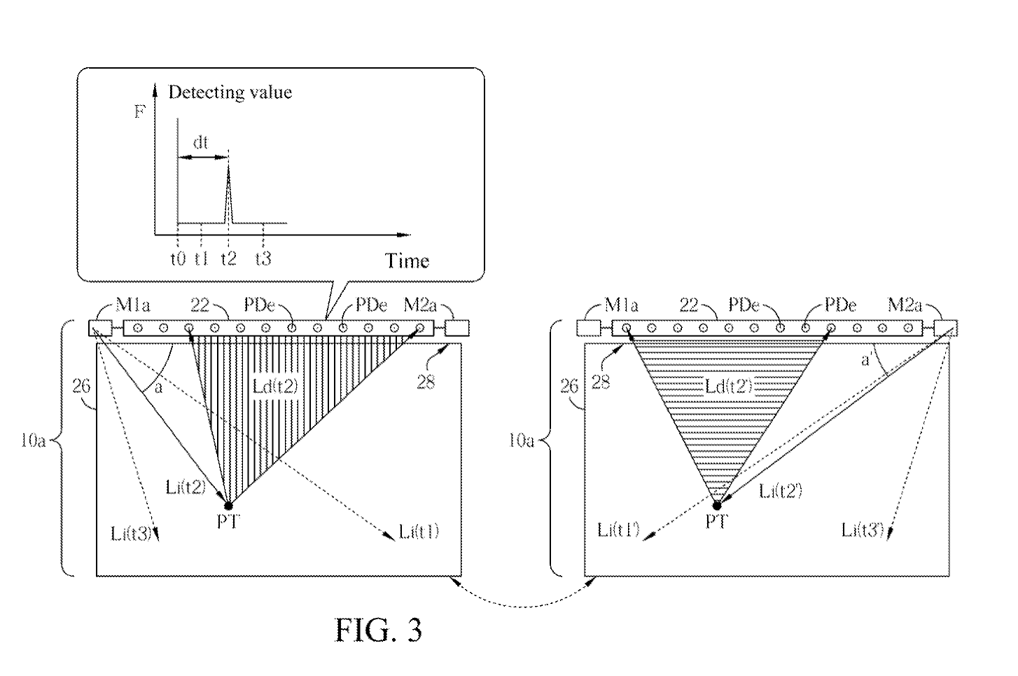

Please refer to FIGS. 2 and 3. FIG. 3 schematically illustrates an optical touch operation implemented in the optical touch system of the present invention. For clarification and brevity, the micro controller unit is not shown in FIG. 3. However, the relation between the basic optical touch structure 10a and the micro controller unit is similar to that of FIG. 2, and is not redundantly described herein. From the time spot t0, the optical touch module M1a sequentially provides the incident rays Li(t1), Li(t2) and Li(t3) in different directions at the time spots t1, t2 and t3, respectively. As discussed in FIG. 2, since the incident ray Li(t0) provided by the scanning unit 12a of the optical touch module M1a at the time spot t0 is received by the detector PD0, the detecting value F outputted from the detecting module 22 is an extreme value. The time spot corresponding to the extreme value denotes the start scanning time. In a case that the incident ray Li(t1) provided at the time spot t1 is not reflected, the detecting value F is maintained at a low value.

At the time spot t2, the incident ray Li(t2) just strikes a touching object PT, and thus a reflected ray Ld(t2) is reflected by the touching object PT. The reflected ray Ld(t2) will be received by corresponding detectors PDe of the detecting module 22. The detecting results of these detectors PDe are added, and thus the detecting value F outputted from the detecting module 22 is a local peak value. Obviously, the reflected ray Ld(t2) is one kind of diffuse-reflected ray. Since the diffuse-reflected ray is widespread, a portion of the diffuse-reflected ray can be received by the detecting module 22. As the fraction of the diffuse-reflected ray received by the detecting module 22 increases, the magnitude of the detecting value F increases. That is, during the optical touch operation is implemented, a time difference dt between the time spots t0 and t2 may be acquired according to the time spots between the extreme value and the local peak value of the detecting value F. According to the time difference dt and the scanning mode (i.e. the change profile of the direction of the incident ray with time), the micro controller unit can calculate the angle a between the incident ray Li(t2) and the edge 28 of the touch-sensitive zone 26.

At the time spot t3, the incident ray Li(t3) does not strike a touching object PT, and thus the incident ray Li(t3) is not reflected by the touching object PT. Meanwhile, the detecting value F is restored to the low value. After the scanning action from the direction Dp (at the time spot t0) to a vertical edge of the touch-sensitive zone 26 in the clockwise direction (through the times spots t1˜t3) is performed, the scanning action from the vertical edge to the direction Dp in a counter-clockwise direction will be performed. Moreover, the scanning action in the clockwise direction and the scanning action in the counter-clockwise direction are cyclically performed to continuously scan the touch-sensitive zone 26.

Similarly, the optical touch module M2a and the optical touch module M1a alternately provide the incident ray. That is, when one of the optical touch modules M1a and M2a provides the incident ray, the other does not provide the incident ray. For example, the optical touch module M2a sequentially provides the incident rays Li(t1′), Li(t2′) and Li(t3′) at the time spots t1′, t2′ and t3′. The time spots t1′, t2′ and t3′ are not necessarily equal to the time spots t1, t2 and t3. At the time spot t2′, the incident ray Li(t2′) just strikes the touching object PT, and thus a reflected ray Ld(t2′) is reflected by the touching point PT. Meanwhile, the detecting value F outputted from the detecting module 22 is a local peak value. By the approach of calculating the angle a, the micro controller unit may calculate the angle a′ between the incident ray Li(t2′) and the edge 28 of the touch-sensitive zone 26. According to the angles a and a′ and the distance between the optical touch modules M1a and M2a, the micro controller unit may locate the position of the touching object PT. In this situation, since the reflected ray Ld(t2′) is also one kind of diffuse-reflected ray, a portion of the diffuse-reflected ray can be received by the detecting module 22.

In an exemplary scanning mode, according to the simple harmonic periodic change of a time sequence in a cycle T, the angle between the incident ray and the edge 28 of the touch-sensitive zone 26 is changed from the angle a_min (at the time spot t0) to the angle a_max (at the time spot (t0+T/2)) and then changed to the angle a_min (at the time spot t0+T). That is, the angle of the incident ray at an arbitrary time spot t may be expressed as the formula: a_min+(a_max−a_min)×(1−cos(2×pi×(t−t0)/T))/2, wherein pi is the ratio of a circle's circumference to its diameter, and cos(•) is a cosine function.

At the time spot t2 when the detecting value corresponding to the incident ray of the optical touch module M1a has the local peak value, the angle between the incident ray and the edge 28 of the touch-sensitive zone 26 (i.e. the angle a as shown in FIG. 3) is obtained as a_min+(a_max−a_min)×(1−cos(2×pi×(dt)/T))/2, wherein dt is the time difference between the time spots occurring the local peak value and the extreme value. Similarly, at the time spot t2′ when the detecting value corresponding to the incident ray of the optical touch module M2a has the local peak value, the angle a′ is calculated by the above approach. According to the angles a and a′ and the distance between the optical touch modules M1a and M2a, the micro controller unit may calculate the position of the touching object PT within the touch-sensitive zone 26.

Particularly, in the above formulae, the position of the origin for calculating the angle a is located at the midpoint of the mirror of the optical touch module M1a; the position of the origin for calculating the angle a is located at the midpoint of the mirror of the optical touch module M2a; and the distance between the optical touch modules M1a and M2a denotes the distance between the midpoints of the mirrors of the optical touch module M1a and the optical touch module M2a. In such way, the position of the touching point PT can be calculated by the micro controller unit.

Consequently, the line passing through the midpoints of the mirrors of the optical touch modules M1a and M2a is spaced from the touching object PT by a distance equal to L×tan(a)×tan(a′)/(tan(a)+tan(a′)), wherein L is the distance between the optical touch modules M1a and M2a, and tan(•) is a tangent function.

In a case that there is an offset between the edge 28 of the touch-sensitive zone 26 and the line passing through the midpoints of the mirrors of the optical touch modules M1a and M2a, the offset may be calculated and compensated by the micro controller unit. In such way, the position of the touching object PT within the touch-sensitive zone 26 can be precisely calculated by the micro controller unit.

The above-mentioned formulae are obtained when the edge 28 of the touch-sensitive zone 26 is parallel with the line passing through the midpoints of the mirrors of the optical touch modules M1a and M2a. However, if the edge 28 of the touch-sensitive zone 26 is not parallel with the line passing through the midpoints of the mirrors of the optical touch modules M1a and M2a, the non-parallel condition may be calculated and compensated by the micro controller unit. In such way, the position of the touching object PT within the touch-sensitive zone 26 can be precisely calculated by the micro controller unit.

Please refer to FIG. 3 again. Due to the arrangement of the detectors PDe, the detectors PDe can detect the diffuse-reflected ray whose direction is different from the incident ray. In other words, the basic optical touch structure 10a as shown in FIGS. 2 and 3 can implement the optical touch operation by receiving a portion of the diffuse-reflected ray.

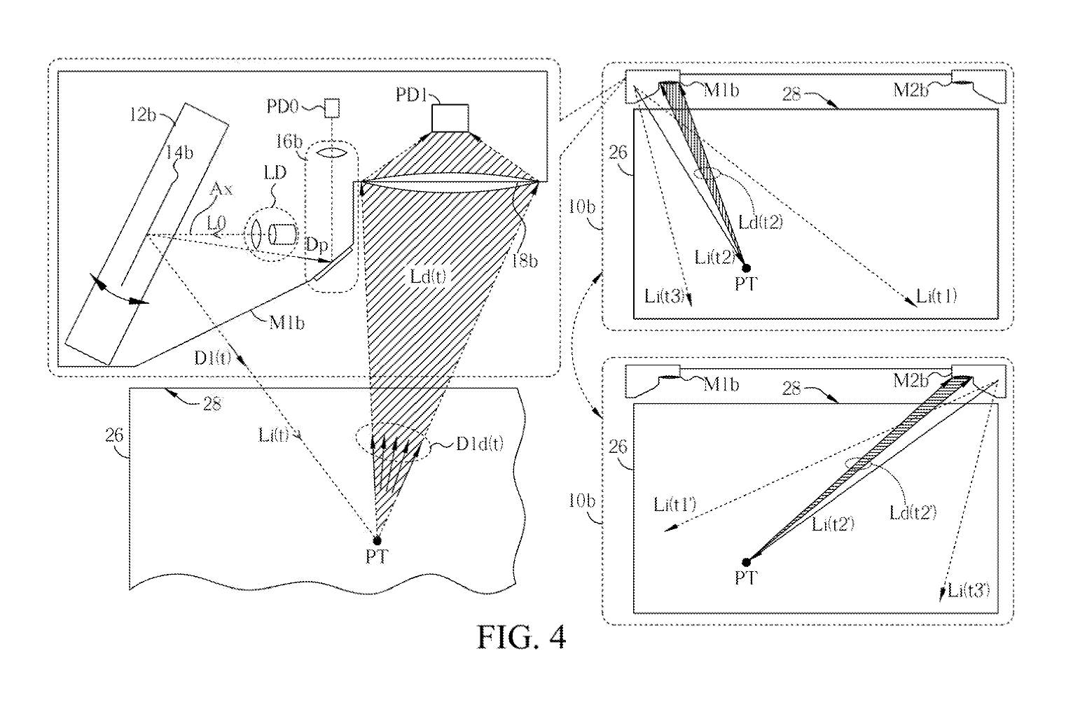

Moreover, in the basic optical touch structure 10a of FIGS. 2 and 3, the detectors PDe are disposed outside the optical touch modules M1a and M2a. That is, the detectors PDe are external detectors. However, these detectors may be integrated into the optical touch modules, so that the optical touch system becomes more compact. FIG. 4 schematically illustrates another basic optical touch structure used in the optical touch system of the present invention. As shown in FIG. 4, the basic optical touch structure 10b comprises two optical touch modules M1b, M2b and a touch-sensitive zone 26. The two optical touch modules M1b, M2b and the detecting module 22 are used for detecting a position of a touching point PT within the touch-sensitive zone 26. The two optical touch modules M1b and M2b are respectively arranged at both sides of an edge 28 of the touch-sensitive zone 26. The method of calculating the position of a touching point PT by the micro controller unit (not shown) is similar to that illustrated in FIG. 3, and is not redundantly described herein.

Since the configurations and functions of the optical touch module M2b are similar to those of the optical touch module M1b, only the operations of the optical touch module M1b will be illustrated as follows. The optical touch module M1b comprises a scanning unit 12b, a light source unit LD, two light collecting units 16b, 18b and two detectors PD0, PD1. The light source unit LD may further comprise an optical mechanism associated with the light source (e.g. LED). The optical mechanism includes for example the optical elements for collecting the ray (e.g. a collimating lens or a lens set) and/or the optical elements for changing the path of the ray (e.g. a mirror or a prism). The light source unit LD provides an initial ray L0 to the scanning unit 12b along an optical axis Ax. Similarly, the light collecting unit 16b (i.e. a basic light collecting unit) may comprise the optical elements for collecting the ray (e.g. a collimating lens or a lens set) and/or the optical elements for changing the path of the ray (e.g. a mirror or a prism). By the light collecting unit 16b, the ray propagating in a predetermined direction Dp is collected to the detector PD0 to be used as a basis of calculating the position of a touching point by the micro controller unit.

The scanning unit 12b comprises a mirror 14b and a servo mechanism (not shown in FIG. 4). The servo mechanism is configured to change an angle of the mirror 14b. For example, the servo mechanism is implemented by a microelectromechanical system (MEMS) technology. By the mirror 14b of the scanning unit 12b, the initial light beam L0 is reflected as an incident ray Li(t) to be directed to the touch-sensitive zone 26 in a direction D1(t). As the angle of the mirror 14b changes with time, the propagating direction D1(t) of the incident ray Li(t) is changed and thus the touch-sensitive zone 26 is scanned by the incident ray Li(t).

When the incident ray Li(t) propagating in the direction D1(t) strikes the touching object PT, a reflected ray Ld(t) is reflected by the touching object PT. By the light collecting unit 18b, the reflected ray Ld(t) propagating in the direction D1d(t) is collected to the detector PD1 in order to implement the optical touch operation. The light collecting unit 18b may comprise the optical elements for collecting the ray (e.g. a collimating lens or a lens set) and/or the optical elements for changing the path of the ray (e.g. a mirror or a prism) in order to collect the a great portion of the reflected ray Ld(t) propagating in the direction D1d(t). An example of the detector PD1 is a photodetector for detecting the intensity of the reflected ray that is collected by the light collecting unit 18b, thereby acquiring the detecting value F.

Like the basic optical touch structure 10a of FIG. 3, the incident ray is alternately provided and detected by the optical touch modules M1b and M2b of the basic optical touch structure 10b. That is, when one of the optical touch modules M1b and M2b provides the incident ray, the other does not provide the incident ray. For example, the optical touch module M1b sequentially provides the incident rays Li(t1), Li(t2) and Li(t3) at the time spots t1, t2 and t3. At the time spot t2 when the incident ray Li(t2) just strikes the touching point PT, the reflected ray Ld(t2) reflected by the touching point PT will be detected by the optical touch module M1b. Meanwhile, the detecting value F is a local peak value. Whereas, since the incident rays Li(t1) and Li(t3) provided at the time spots t1 and t3 are not reflected by the touching point PT, the detecting value F is maintained at a low value.

In a case that the optical touch module M1b does not provide the incident ray, the optical touch module M2b is responsible for providing the incident ray. For example, the optical touch module M2b sequentially provides the incident rays Li(t1′), Li(t2′) and Li(t3′) at the time spots t1′, t2′ and t3′. At the time spot t2′ when the incident ray Li(t2′) just strikes the touching point PT, a reflected ray Ld(t2′) reflected by the touching point PT will be detected by the optical touch module M2b. According to the detecting values of the optical touch modules M1b and M2b and the scanning mode, the angle between the incident ray Li(t2) and the edge 28 and the angle between the incident ray Li(t2′) and the edge 28 will be calculated. According to the angles and the distance between the optical touch modules M1b and M2b, the position of the touching point PT can be realized. Consequently, the optical touch purpose is achieved.

From the above discussions in FIG. 4, the light collecting unit 18b is configured to collect a portion of diffuse-reflected ray Ld(t) propagating in the direction D1d(t). That is, the optical touch operation of the basic optical touch structure 10b is implemented by means of the diffuse-reflected ray. In comparison with the optical touch technology using the retro-reflected ray, the optical touch technology using the diffuse-reflected ray can result in an enhanced signal-to-noise ratio. Moreover, the optical touch technology using the diffuse-reflected ray can simplify the arrangement of the detectors. In other words, it is not necessary to install lots of detectors along the three edges of the touch-sensitive zone. Consequently, the optical touch technology of the present invention is cost-effective.

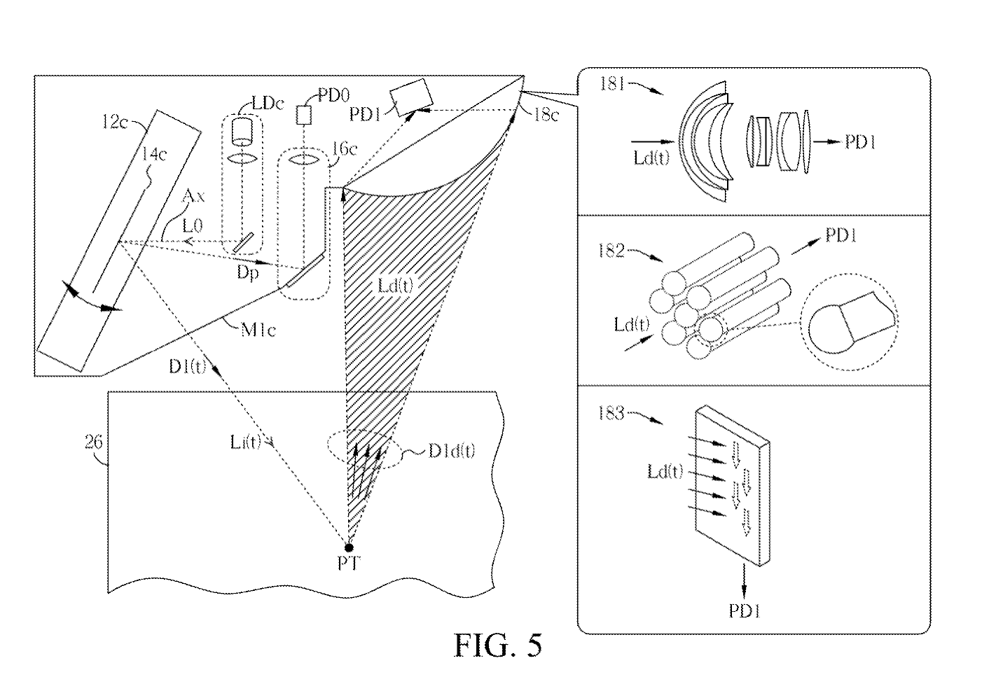

FIG. 5 schematically illustrates a variant example of an optical touch module used in the basic optical touch structure of FIG. 4. The optical touch module M1c is derived from the optical touch module M1b of FIG. 4. In other words, the optical touch module M1c may be used in the basic optical touch structure 10b of FIG. 4.

The optical touch module M1c comprises a scanning unit 12c, a light source unit LDc, two light collecting units 16c, 18c and two detectors PD0, PD1. The light source unit LDc may further comprise an optical mechanism associated with the light source (e.g. LED). The optical mechanism includes for example the optical elements for collecting the ray (e.g. a collimating lens or a lens set) and/or the optical elements for changing the path of the ray (e.g. a mirror or a prism). The light source unit LDc provides an initial ray L0 to the scanning unit 12c along an optical axis Ax. Similarly, the light collecting unit 16c (i.e. a basic light collecting unit) may comprise the optical elements for collecting the ray (e.g. a collimating lens or a lens set) and/or the optical elements for changing the path of the ray (e.g. a mirror or a prism). By the light collecting unit 16c, the ray propagating in a predetermined direction Dp is collected to the detector PD0 to be used as a basis of calculating the position of a touching point by the micro controller unit.

The scanning unit 12c comprises a mirror 14c and a servo mechanism (not shown in FIG. 5). The servo mechanism is configured to change an angle of the mirror 14c. For example, the servo mechanism is implemented by a microelectromechanical system (MEMS) technology. By the mirror 14c of the scanning unit 12c, the initial light beam L0 is reflected as an incident ray Li(t) to be directed to the touch-sensitive zone 26 in a direction D1(t). As the angle of the mirror 14c changes with time, the propagating direction D1(t) of the incident ray Li(t) is changed and thus the touch-sensitive zone 26 is scanned by the incident ray Li(t).

When the incident ray Li(t) propagating in the direction D1(t) strikes the touching object PT, a reflected ray Ld(t) is reflected by the touching object PT. By the light collecting unit 18c, the reflected ray Ld(t) propagating in the direction D1d(t) is collected to the detector PD1 in order to implement the optical touch operation. The light collecting unit 18c can collect the a great portion of the reflected ray Ld(t) propagating in the direction D1d(t). An example of the detector PD1 is a photodetector for detecting the intensity of the reflected ray that is collected by the light collecting unit 18c, thereby acquiring the detecting value F.

Moreover, some examples 181˜183 of the light collecting unit 18c are also shown in FIG. 5. The light collecting unit 181 employs a wide-angle fisheye lens to collect a great portion of the diffuse-reflected ray Ld(t) to the detector PD1. The light collecting unit 182 employs an optical fiber string having a lens-like structure to collect a great portion of the diffuse-reflected ray Ld(t) to the detector PD1. The optical fiber string comprises multiple strands of optical fibers. The terminal of each optical fiber is formed as a light collecting lens for collecting the reflected ray Ld(t). The light collecting unit 183 employs a light collecting plate to collect a great portion of the diffuse-reflected ray Ld(t) to the detector PD1. For example, the light collecting plate is the light collector found in the conventional solar cell. The light collecting plate has a light guide microstructure to transmit the energy of the collected ray to a side of the light collecting plate so as to be received and sensed by the detector PD1. Alternatively, two or three of the light collecting units 181, 182 and 183 may be integrated into a single light collecting unit 18c. Moreover, each of the light collecting units 181, 182 and 183 may be used as the light collecting unit 18b of FIG. 4.

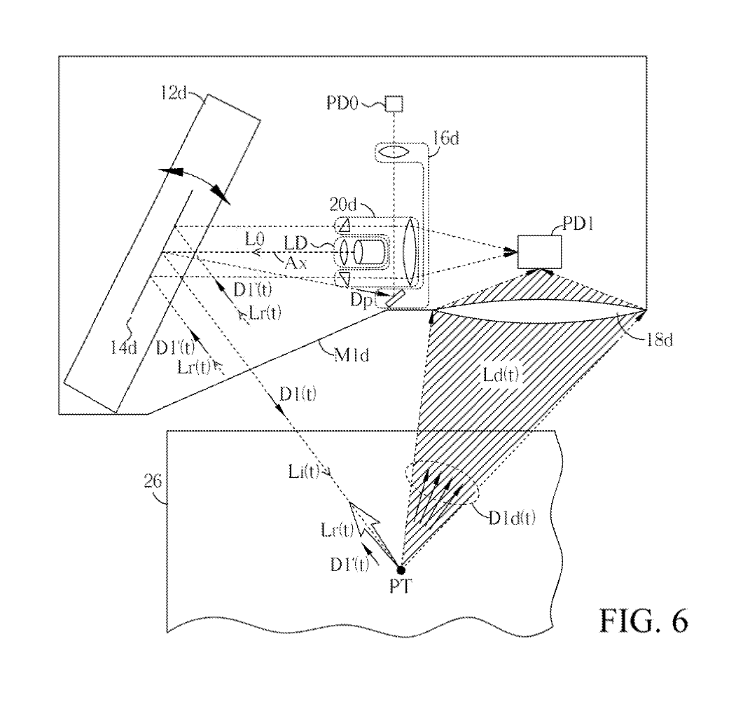

In the above embodiments of FIGS. 2-5, the optical touch operation is implemented by using the diffuse-reflected ray. Moreover, the optical touch operation may be further implemented by using the retro-reflected ray. Hereinafter, an optical touch operation implemented by using the retro-reflected ray will be illustrated with reference to FIG. 6.

FIG. 6 schematically illustrates another exemplary optical touch module used in the basic optical touch structure of the present invention. The optical touch module M1d comprises a scanning unit 12d, a light source unit LD, three light collecting units 16d, 18d, 20d and two detectors PD0, PD1. The light source unit LD may further comprise an optical mechanism associated with the light source (e.g. LED). The light source unit LD provides an initial ray L0 to the scanning unit 12d along an optical axis Ax. The light collecting unit 16d is a basic light collecting unit. By the light collecting unit 16d, the ray propagating in a predetermined direction Dp is collected to the detector PD0 to be used as a basis of calculating the position of a touching point by the micro controller unit. That is, the ray propagating in a predetermined direction Dp is used as a basic ray for calculating the position of a touching point.

The scanning unit 12d comprises a mirror 14d and a servo mechanism (not shown in FIG. 6). The servo mechanism is configured to change an angle of the mirror 14d. For example, the servo mechanism is implemented by a microelectromechanical system (MEMS) technology. By the mirror 14d of the scanning unit 12d, the initial light beam L0 is reflected as an incident ray Li(t) to be directed to the touch-sensitive zone 26 in a direction D1(t). As the angle of the mirror 14d changes with time, the propagating direction D1(t) of the incident ray Li(t) is changed and thus the touch-sensitive zone 26 is scanned by the incident ray Li(t).

When the incident ray Li(t) propagating in the direction D1(t) strikes the touching object PT, a reflected ray is reflected by the touching object PT. Consequently, a great portion of the diffuse-reflected ray Ld(t) propagating in the direction D1d(t) is received by the light collecting unit 18d and collected to the detector PD1. The light collecting unit 18d may be designed to have the same configuration as the light collecting unit 18b or 18d.

On the other hand, when the incident ray Li(t) strike the touching point PT, a retro-reflected ray Lr(t) is produced because of retro-reflection. The traveling direction of the retro-reflected ray Lr(t) is opposed to the direction D1(t). The retro-reflected ray Lr(t) is directed to the mirror 14d in the direction D1′(t). By the mirror 14d, the retro-reflected ray Lr(t) is reflected back to the light collecting unit 20d along the optical axis Ax. By the light collecting unit 20d, the retro-reflected ray Lr(t) is collected to the detector PD1. The light collecting unit 20d is disposed around the light source unit LD. The light collecting unit 16d may comprise the optical elements for collecting the ray (e.g. a collimating lens or a lens set) and/or the optical elements for changing the path of the ray (e.g. a mirror or a prism), so that the retro-reflected ray Lr(t) is collected to the detector PD1 along the optical axis Ax. In this embodiment, the light collecting unit 16d comprises a light collecting lens with a circular aperture. The initial ray L0 is permitted to pass through the circular aperture. The remaining part of the light collecting lens can collect the retro-reflected ray Lr(t) whose direction is opposed to the direction of the initial ray L0.

From the above discussions, by the light collecting units 18d and 20d, the optical touch module M1d can collect the retro-reflected ray and a great portion of the diffuse-reflected ray. Consequently, the signal-to-noise ratio of the optical touch operation will be enhanced, and a precise optical touch technology will be achieved.

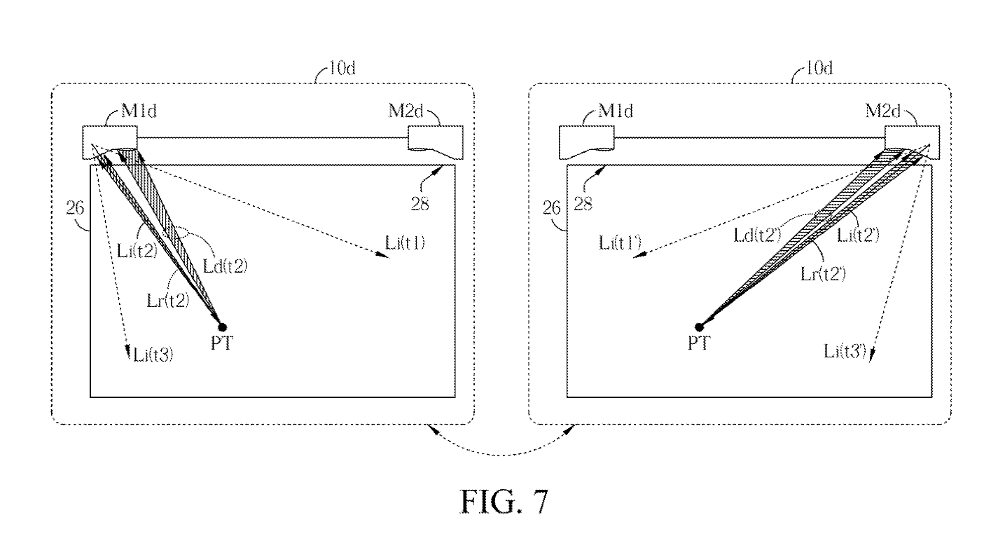

FIG. 7 schematically illustrates another basic optical touch structure used in the optical touch system of the present invention. As shown in FIG. 7, the basic optical touch structure 10d comprises two optical touch modules M1d, M2d and a touch-sensitive zone 26. The two optical touch modules M1d and M2d are respectively arranged at both sides of an edge 28 of the touch-sensitive zone 26. In this embodiment, each of the optical touch modules M1d and M2d has the same configuration as the optical touch module M1d of FIG. 6. For clarification and brevity, the micro controller unit is not shown in FIG. 7. However, the relation between the basic optical touch structure 10d and the micro controller unit is similar to that of FIG. 2, and is not redundantly described herein.

In the basic optical touch structure 10d, the incident ray is alternately provided and detected by the optical touch modules M1d and M2d. For example, the optical touch module M1d sequentially provides the incident rays Li(t1), Li(t2) and Li(t3) at the time spots t1, t2 and t3. At the time spot t2 when the incident ray Li(t2) just strikes the touching object PT, the diffuse-reflected ray Ld(t2) and the retro-reflected ray Lr(t2) reflected by the touching object PT will be detected by the optical touch module M1d. Meanwhile, the detecting value F is a local peak value. Whereas, since the incident rays Li(t1) and Li(t3) provided at the time spots t1 and t3 are not reflected by the touching object PT, the detecting value F is maintained at a low value. Since the retro-reflected ray and a great portion of the diffuse-reflected ray are collected by the optical touch module Mid, the local peak value of the detecting value F become more noticeable. Consequently, the signal-to-noise ratio of the optical touch operation will be enhanced, and the position of the touching point PT can be located more precisely.

In a case that the optical touch module M1d does not provide the incident ray, the optical touch module M2d is responsible for providing the incident ray. For example, the optical touch module M2d sequentially provides the incident rays Li(t1′), Li(t2′) and Li(t3′) at the time spots t1′, t2′ and t3′. At the time spot t2′ when the incident ray Li(t2′) just strikes the touching point PT, a reflected ray Ld(t2′) and a retro-reflected ray Lr(t2′) reflected by the touching object PT will be detected by the optical touch module M2d. According to the detecting values of the optical touch modules M1d and M2d and the scanning mode, the angle between the incident ray Li(t2) and the edge 28 and the angle between the incident ray Li(t2′) and the edge 28 will be calculated. According to the angles and the distance between the optical touch modules M1d and M2d, the position of the touching object PT can be realized. Consequently, the optical touch purpose is achieved.

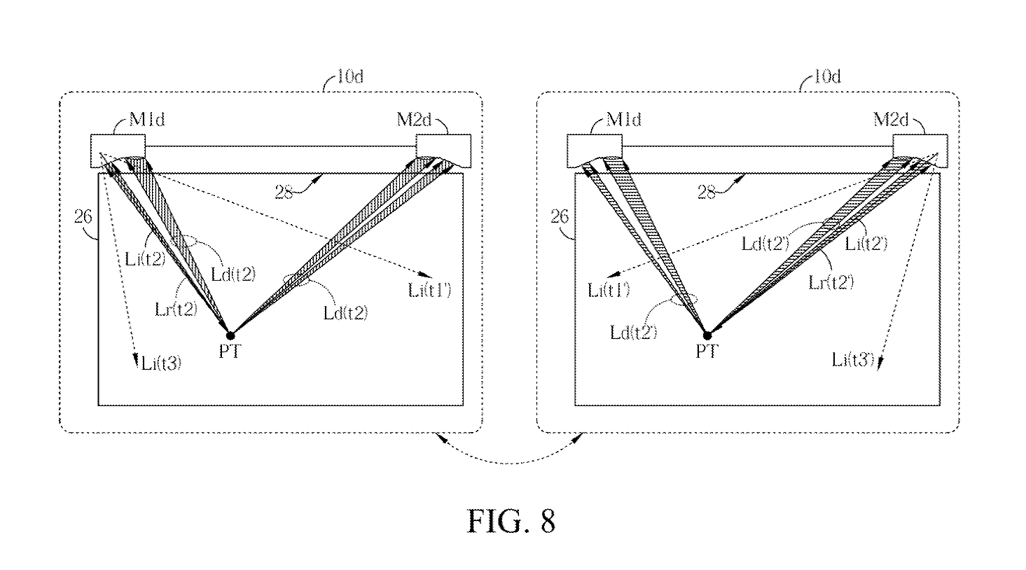

FIG. 8 schematically illustrates a variant example of a basic optical touch structure of FIG. 7. Similarly, in the basic optical touch structure 10d, the incident ray is alternately provided and detected by the optical touch modules M1d and M2d. However, when one of the optical touch modules M1d and M2d provides the incident ray, the reflected ray is received and detected by both of the optical touch modules M1d and M2d. According to the sum of the detecting values obtained by the two optical touch modules, the optical touch operation is implemented.

For example, the optical touch module M1d sequentially provides the incident rays Li(t1), Li(t2) and Li(t3) at the time spots t1, t2 and t3. At the time spot t2 when the incident ray Li(t2) just strikes the touching object PT, the diffuse-reflected ray Ld(t2) and the retro-reflected ray Lr(t2) reflected by the touching object PT will be detected by the optical touch module M1d. At the same time, the diffuse-reflected ray Ld(t2) is also detected by the optical touch module M2d. The detecting values obtained by the optical touch modules M1d and M2d are added, so that the detecting value F is a local peak value. Whereas, since the incident rays Li(t1) and Li(t3) provided at the time spots t1 and t3 are not reflected by the touching object PT, the detecting value F is maintained at a low value. Since the retro-reflected ray and the diffuse-reflected ray are simultaneously collected by the optical touch modules M1d and M2d, the local peak value of the detecting value F become more noticeable. Consequently, the signal-to-noise ratio of the optical touch operation will be enhanced, and the position of the touching object PT can be located more precisely.

In a case that the optical touch module M1d does not provide the incident ray, the optical touch module M2d is responsible for providing the incident ray. For example, the optical touch module M2d sequentially provides the incident rays Li(t1′), Li(t2′) and Li(t3′) at the time spots t1′, t2′ and t3′. At the time spot t2′ when the incident ray Li(t2′) just strikes the touching object PT, a reflected ray Ld(t2′) and a retro-reflected ray Lr(t2′) reflected by the touching object PT will be detected by the optical touch module M2d. At the same time, the diffuse-reflected ray Ld(t2′) is also detected by the optical touch module M1d.

Please refer to FIG. 4 again. The optical touch operation of the basic optical touch structure 10d of FIG. 8 may be applied to the basic optical touch structure 10b of FIG. 4. That is, when one of the optical touch modules M1d and M2d of the basic optical touch structure 10b provides the incident ray, the diffuse-reflected ray is received and detected by both of the optical touch modules M1d and M2d.

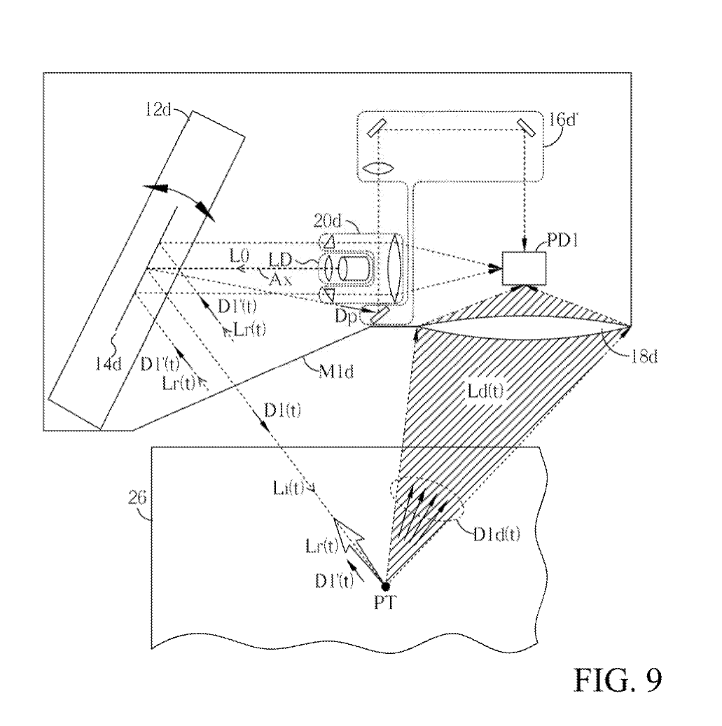

FIG. 9 schematically illustrates a variant example of the optical touch module of FIG. 6. In comparison with the embodiment of FIG. 6, the optical touch module M1d of FIG. 9 comprises a light collecting unit 16d′. By the light collecting unit 16d′, the ray propagating in a predetermined direction Dp is collected to the detector PD1 to be used as a basis of calculating the position of a touching point. Consequently, the detector PD0 used in the embodiment of FIG. 6 may be exempted from the optical touch module of FIG. 9. The light collecting unit 16d′ may comprise the optical elements for collecting the ray (e.g. a collimating lens or a lens set) and/or the optical elements for changing the path of the ray (e.g. a mirror or a prism), so that the ray propagating in the direction Dp is collected to the detector PD1. As previously described in FIG. 2, since the ray propagating in the direction Dp is obtained when the initial ray L0 provided by light source unit LD is directly reflected by the mirror 14d, the intensity of the ray propagating in the direction Dp is stronger than the intensity of the ray required to implement the optical touch operation. Optionally, the light collecting unit 16d′ may further comprises a light attenuator (not shown) for attenuating the light intensity. After the intensity of the ray propagating in the direction Dp is attenuated, the attenuated ray is transmitted to the detector PD1.

In the embodiments of FIGS. 2-9, the detector PD1 is a single photodetector for detecting the light intensity. Alternatively, the detector PD1 is a photodetector array capable of quickly acquiring a two-dimensional image. In a case that the detector PD1 is a photodetector array, the image reflected by the touching point can be quickly shot, and the optical touch operation can be implemented by comparing the images shot at different time spots with each other.

From the above description, the optical touch system of the present invention utilizes the diffuse-reflected ray and the retro-reflected ray from the touching point to increase the detecting value. As a consequence, the signal-to-noise ratio and the detecting precision of the optical touch operation are enhanced. Moreover, in comparison with the conventional light-sheltering optical touch technology necessary to install widespread detectors along the three edges of the touch-sensitive zone, the optical touch system of the present invention has a simplified structure and low operating cost.

Moreover, the wavelengths of the rays outputted from the light sources of the present invention are not limited to the visible spectrum (e.g. 400 nm˜780 nm). Nevertheless, the wavelengths of the rays outputted from the light sources can also be applied to the invisible electromagnetic spectrum (e.g. the near infrared spectrum of about 850 nm). That is, wavelengths of the incident ray and the reflected rays mentioned above are in the visible or invisible spectrum. Moreover, the light collecting units used in the optical touch system can be used for collecting the rays in the visible or invisible spectrum.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch system, comprising:
a touch-sensitive zone;
a first optical touch module arranged at a first side of the touch-sensitive zone for providing a first incident ray to the touch-sensitive zone; and
a second optical touch module arranged at a second side of the touch-sensitive zone for providing a second incident ray to the touch-sensitive zone, wherein the first incident ray and the second incident ray are alternately provided by the first optical touch module and the second optical touch module, wherein when the first incident ray and the second incident ray strike a touching object within the touch-sensitive zone, a plurality of reflected rays are reflected by the touching object, wherein the reflected rays are detected by the first optical touch module and the second optical touch module, so that a plurality of detecting values are outputted; and
a micro controller unit for receiving the detecting values from the first optical touch module and the second optical touch module, thereby calculating a position of the touching point within the touch-sensitive zone.

2. The optical touch system as claimed in claim 1, wherein the first optical touch module comprises:
a first detector;
a first light collecting unit, wherein when the first incident ray and the second incident ray strike the touching object to produce the a plurality of reflected rays, diffuse-reflected rays of the a plurality of reflected rays are collected to the first detector by the first light collecting unit; and
a second light collecting unit, wherein when the first incident ray strikes the touching object to produce the a plurality of reflected rays, a retro-reflected ray of the a plurality of reflected rays is collected to the first detector by the second light collecting unit.

3. The optical touch system as claimed in claim 2, wherein the first optical touch module further comprises a first scanning unit including a light source unit and a rotatable mirror, wherein the light source unit is configured to provide the first incident ray to the touch-sensitive zone.

4. The optical touch system as claimed in claim 1, wherein the second optical touch module comprises:
a second detector;
a third light collecting unit, wherein when the first incident ray and the second incident ray strike the touching point to produce the a plurality of reflected rays, diffuse-reflected rays of the a plurality of reflected rays are collected to the second detector by the third light collecting unit; and
a fourth light collecting unit, wherein when the second incident ray strikes the touching point to produce the a plurality of reflected rays, a retro-reflected ray of the a plurality of reflected rays is collected to the second detector by the fourth light collecting unit.

5. The optical touch system as claimed in claim 4, wherein the second optical touch module further comprises a second scanning unit including a light source unit and a rotatable mirror, wherein the light source unit is configured to provide the second incident ray to the touch-sensitive zone.

6. An optical touch method for use in an optical touch system including a first optical touch module and a second optical touch module, the optical touch method comprising steps:
alternately providing a first incident ray and a second incident ray by the first optical touch module and the second optical touch module, respectively;
detecting the light intensities of a plurality of reflected rays produced when the first incident ray and the second incident ray strike a touching object, thereby acquiring a plurality of detecting values; and
calculating a position of the touching object within a touch-sensitive zone according to the a plurality of detecting values.

7. The optical touch method as claimed in claim 6, wherein when the first incident ray and the second incident ray are respectively reflected by a first mirror of the first optical touch module and a second mirror of the second optical touch module, a plurality of basic rays with the maximum light intensity are detected by the first optical touch module and the second optical touch module, so that a plurality of basic values are acquired.

8. The optical touch method as claimed in claim 7, wherein by rotating the first mirror of the first optical touch module and the second mirror of the second optical touch module, the first incident ray and the second incident ray are respectively directed to the touch-sensitive zone in different directions.

9. The optical touch method as claimed in claim 8, wherein when the first incident ray and the second incident ray strike on the touching objects, the a plurality of reflected rays with different light intensities are produced, wherein the a plurality of reflected rays are detected by the first optical touch module and the second optical touch module, so that the a plurality of detecting values are acquired.

10. The optical touch method as claimed in claim 9, wherein the position of the touching point within a touch-sensitive zone is calculated according to the a plurality of detecting values and the a plurality of basic values.

11. An optical touch system, comprising:
a touch-sensitive zone;
a first optical touch module comprising:
a first scanning unit for providing a first incident ray in a first direction; and
an external detector for detecting a reflected ray corresponding to the first incident ray in a second direction, wherein the second direction is not parallel with the first direction; and
a micro controller unit for controlling the first optical touch module and receiving a detecting value from the external detector, thereby calculating a position of a touching point within a touch-sensitive zone.

12. The optical touch system as claimed in claim 11, further comprising:
an internal detector; and
a first light collecting unit for receiving a reflected ray corresponding to the first incident ray in a third direction, so that the reflected ray is collected to the internal detector, wherein the third direction is not parallel with the first direction.

13. The optical touch system as claimed in claim 12, further comprising a second light collecting unit for receiving a retro-reflected ray corresponding to the first incident ray, so that the retro-reflected ray is collected to the internal detector.

14. The optical touch system as claimed in claim 12, further comprising a second optical touch module, wherein the external detector is included in the second optical touch module, and the second optical touch module further comprises:
a second scanning unit, wherein when the first incident ray is not provided by the first scanning unit, the second scanning unit provides a second incident ray in a fourth direction; and
a third light collecting unit for receiving a reflected ray corresponding to the second incident ray in a fifth direction, so that the reflected ray is collected to the external detector, wherein the fifth direction is not parallel with the fourth direction.

15. The optical touch system as claimed in claim 14, wherein a reflected ray corresponding to the second incident ray in a sixth direction is further received by the first light collecting unit of the first optical touch module, so that the reflected ray is collected to the internal detector of the first optical touch module.

16. An optical touch method for use in an optical touch system including a first optical touch module and a second optical touch module, the first optical touch module comprising a first scanning unit, the second optical touch module comprising a second detector, the optical touch method comprising steps:
providing a first incident ray in a first direction by the first scanning unit; and
allowing the second detector to receive a reflected ray corresponding to the first incident ray in a second direction, wherein the second direction is not parallel with the first direction.

17. The optical touch method as claimed in claim 16, wherein the first optical touch module further comprises a first detector, and the optical touch method further comprises a step of allowing the first detector to receive a reflected ray corresponding to the first incident ray in a third direction, wherein the third direction is not parallel with the first direction.

18. The optical touch method as claimed in claim 17, wherein the first optical touch module further comprises a retro-reflection light collecting unit, and the optical touch method further comprises a step of receiving a retro-reflected ray corresponding to the first incident ray in the first direction, so that the retro-reflected ray is collected to the first detector.

19. The optical touch method as claimed in claim 16, wherein the first optical touch module further comprises a third detector, and the second optical touch module further comprises a second scanning unit, wherein the optical touch method further comprises steps of:
providing a second incident ray in a third direction by the second scanning unit; and
allowing the third detector to receive a reflected ray corresponding to the second incident ray in a fourth direction, wherein the fourth direction is not parallel with the third direction.
